(19) United States
(12) Patent Application Publication
(10) Pub. No.: US 2020/0145534 A1
(43) Pub. Date: May 7, 2020

(54) INTELLIGENT MULTI-CHANNEL INTERACTION MANAGEMENT WITHIN A CONTACT CENTER COMMUNICATION SYSTEM

(71) Applicant: Avaya Inc., Santa Clara, CA (US)

(72) Inventors: David Chavez, Broomfield, CO (US); Laurent Philonenko, San Francisco, CA (US)

(21) Appl. No.: 16/183,159

(22) Filed: Nov. 7, 2018

(51) Int. Cl. H04M 3/523; G06Q 10/06; G06Q 30/02

(52) U.S. Cl. CPC H04M 3/5233; G06Q 30/0281; G06Q 10/063112

(57) ABSTRACT

Systems, methods, software and apparatus to enable a contact center to handle dynamic service requests to minimize the disruption of unexpected events. An intelligence-supported queue enables the contact center to track, manage, maintain, assign, and route: (1) current multi-channel interactions already in an agent's split; (2) dynamically-created multi-channel interactions which haven't been queued or assigned to a split; and (3) dynamically-created multi-channel interactions which have been assigned to an agent with the new attributes.

### FIELD

The disclosure relates generally to contact centers and particularly to systems for routing communications and service requests in a contact center.

### BACKGROUND

Vector Directory Numbers (VDNs) and splits/skills have similar general functions. Namely, both solutions offer routing and queuing functionality for phone calls incoming to a contact center. There are differences between the two solutions, however. VDNs, on the one hand, provide a specific extension for a customer to reach a contact center whereas a split/skill directs the customer to a particular agent qualified to handle the customer's issue.

### SUMMARY

A VDN will often route and queue incoming communications to a large, unsorted pool of contact center agents. These agents will have calls assigned to them based almost entirely on availability. Contact centers often use static routing mechanisms for a VDN and skill-based routing. For example, a contact center may have static/hard-coded set of rules to apply to customers that are assigned to the VDN. The most typical approach for a VDN is to apply a first-in-first-out (FIFO) rule set. This approach works well for low-priority customers or simple questions that do not require a skilled agent. In general, a VDN will provide a relatively efficient solution for processing incoming communications.

Skill-based/split routing is less efficient than most VDN solutions, as it requires more agents, but offers a better quality of service and is better-suited for matching a skilled agent with a customer, and often results in more efficient, and therefore, faster handling of a service request. As can be appreciated, skill-based routing is often preferred for customers or questions that require a higher-degree of skill or training from the agent. A VDN, in comparison, displays efficiencies in the speed of connection to an agent, but may have slower handling times because the agents are assigned without regard to skill. In some cases, a customer may need to be transferred to another agent with the skill(s) required to handle the customer's request.

It is with respect to these and other needs that embodiments of the present disclosure have been contemplated. Specifically, a contact center routing engine is constantly trying to balance the speed of initial agent assignment against call handling times. Depending upon the desired performance of a particular contact center, one contact center routing engine may need to behave differently from other routing engines in other contact centers. Furthermore, a contact center routing engine that applies a single type of routing solution may face significant challenges when unexpected volumes of communications are received at the contact center for a particular skill group or for a new problem that is not related to a predefined skill group.

Embodiments of the present disclosure provide a mechanism to ensure that each impacted skill-based queue or split handles unexpected events in a smarter manner to minimize the disruption of the unexpected and/or dynamic events. In some embodiments, an intelligence-supported queue is provided with the ability to track, manage, maintain, assign, and route: (1) current multi-channel interactions already in an agent's split; (2) dynamically-created multi-channel interactions which haven't been queued or assigned to a split; and (3) dynamically-created multi-channel interactions which have been assigned to an agent with the new attributes/skills.

In some embodiments, the intelligence-supported queue includes a management instruction set that orchestrates, prioritizes, and computes the wait time for a customer of a multi-channel interaction that may potentially be serviced by an agent assigned to the intelligence-supported queue and determines a best course of routing for the current and dynamically-created interactions to minimize the impact on the current split depending on the action that needs to be taken. In some embodiments, the intelligence-supported queue may also include an administration Application Programming Interface (API) that will allow administrators and supervisors to use new algorithms and data sources along with prior data to improve the performance of the intelligence-supported queue across multiple locations, or Automatic Call Distributors (ACDs) in a call center.

In some embodiments, the configuration of the original VDN implements the general goals of the contact center, but the intelligence-supported queue may enable the contact center to adapt to unexpected events or changes in goals over time. Additionally, intelligence-supported queues may be added to/layered with existing routing algorithms. As a non-limiting example, Agent1 may be assigned to a split for a particular VDN and then an “unforeseen event” occurs that results in additional incoming volume for the contact center. In this example, a set of Agents, X, may have the characteristics to discuss/handle customers calling about the incident. Say that Agent1 is in the set X. Agent1 is a member of the split served by the VDN in question with all of the normal characteristics to be expected. Simultaneously, Agent1 is also member of SmartQ, Xq. Each agent belonging to SmartQ, Xq, also has a set of characteristics that is specific to that SmartQ, Xq, and independent of the before mentioned split. Agent1 will serve a customer either from the VDN or from SmartQ Xq, whichever occurs first. When a contact associated with the customer is assigned to Agent1, the state of Agent1 is changed to “ACTIVE” in whatever queue the agent was selected in and tagged “NOT AVAILABLE” in the other queue. Thus, Agent1 will exist within both queues simultaneously and when the agent is servicing a request from one queue, the agent's state in the other queue is automatically updated to have an opposite value. In other words, agents are allowed to stay in their original split and still receive dynamically created interactions. Once the contact is totally handled (including any auxiliary work) then the state is released back to “AVAILABLE” and Agent1 is once again “AVAILABLE” in both queues (e.g., the VDN and the SmartQ, Xq).

As can be appreciated, embodiments of the present disclosure enable a contact center to use FIFO, metrics (gold customers get the priority), or other original routing solutions and then supplement those solutions with an additional intelligence-supported queue that intelligently responds to the occurrence of dynamic events.

In some embodiments, a method is provided that generally comprises:

monitoring and tracking in real-time the handling of service requests in a contact center to determine queue information;

receiving a new service request in a service queue;

processing the new service request to determine how to route the new service request based on a routing algorithm and routing the new service request to an agent for handling;

receiving a dynamic service request in the service queue;

processing the queue information to determine how to route the dynamic service request for handling.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “split” and/or “skill group” may be used interchangeably and may include any type of definition that includes, skills (e.g., agent skills). In addition, a skill group may include a broader definition that includes attributes (e.g., an attribute group), such as support (e.g., supports a specific type of communication), etc. An agent may have a particular state, such as, AVAILABLE, OFFLINE, ONLINE, etc. within a skill or different skills and such states may be dependent upon the state of the agent in another skill or queue.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1A is a block diagram of a first illustrative system 100 for processing and routing service requests in a contact center.

FIG. 1B is a block diagram of an embodiment of system 100 using intelligence-supported queues to process and route service requests in a contact center.

FIG. 2 is a flow diagram of a process for processing and routing service requests in a contact center.

FIG. 3 is a flow diagram of a process for dynamically managing splits for routing communications in a contact center.

FIG. 4 is a flow diagram of a process for dynamically creating new splits/contact center queues in a contact center.

FIG. 5 is a flow diagram of a process for dynamically modifying splits/contact center queues in a contact center.

FIG. 6 is a flow diagram of a process for dynamically deleting splits/contact center queues in a contact center.

FIG. 7 is a block diagram of a computer used to implement the intelligence-supported queues in accordance with embodiments of the present disclosure.

### DETAILED DESCRIPTION

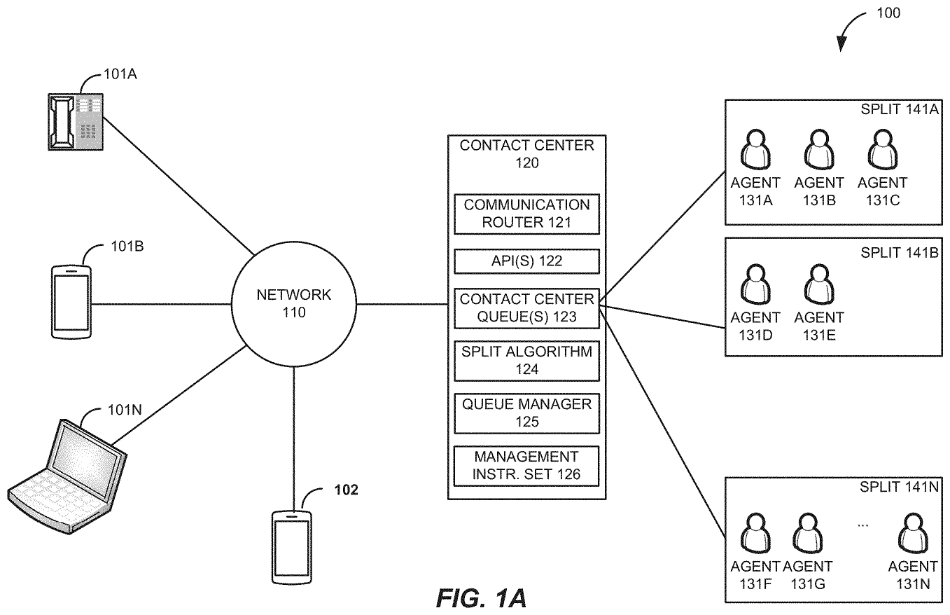

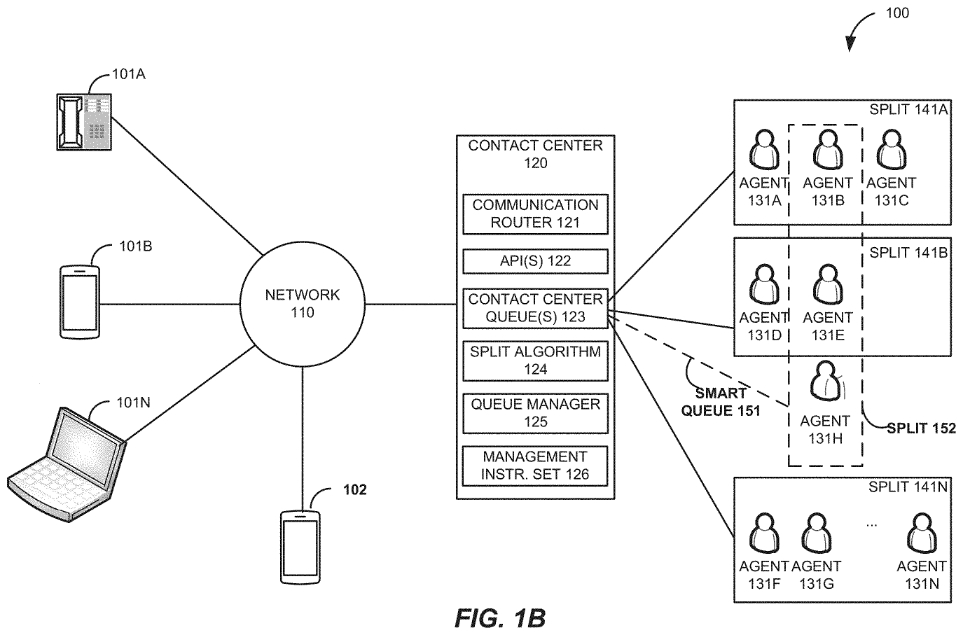

FIG. 1A is a block diagram of a first illustrative system 100 for processing and routing service requests in a contact center. Contact centers may be used to route callers, or users who seek help to an appropriate operator or agent. The first illustrative system 100 comprises communication devices 101A-N, network 110, contact center 120, and agents 131A-N in splits 141A-N. Split 141A includes agents 131A-C, split 141B includes agents 131D-E, and split 141N comprises agents 131F-N. Splits are for illustrative purposes only and may include more or fewer agents than shown.

The communication devices 101A-101N can be or may include any communication device, such as a Personal Computer (PC), a telephone, a video system, a cellular telephone, a Personal Digital Assistant (PDA), a laptop, a tablet device, a notebook device, a smart phone, a wearable device, and the like. The communication devices 101A-101N are devices through which users may conduct communication sessions with contact center 120. Contact center 120 may receive service requests over multiple channels. The different channels may comprise different types of service requests (i.e. phone calls, email, chat sessions, etc.), requests received over different networks (i.e. circuit-switched, packet-switched, etc.), requests from users dialing different numbers to access the contact center, etc. Examples of communication sessions include voice calls, video calls, conference calls, VoIP calls, online chats, text messages (i.e. SMS messages), and/or other types of communication sessions. For example, device 101A may be in a circuit-switched phone call with agent 131A. In another example, device 101B may be exchanging text messages with agent 131C. In yet another example, the user of device 101C may be sending an email that is transferred to contact center 120.

As shown in FIG. 1A, any number of communication devices 101A-101N may be connected to the network 110. Furthermore, although only one network 110 is shown, communication devices 101A-N may connect to contact center 120 via different communication networks, such as a Public Switched Network (PSTN) and/or other circuit-switched networks, IP networks and/or other packet-switched networks.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), H.323, video protocols, email protocols, cellular protocols, Instant Messaging (IM) protocol, and/or the like. Thus, the network 110 is an electronic communication network 110 configured to carry electronic messages via packets and/or circuit switched communications.

The contact center 120 can be or may include any hardware coupled with software that can manage communications (incoming and/or outgoing) that are routed to and/or from agents. The contact center 120 may comprise multiple distributed contact centers 120. For example, the contact center 120 may comprise a contact center 120 in the United States and a contact center 120 in India. Additionally, agents within a skill group may be separately located.

The contact center 120 further comprises a communication router 121, Application Program Interface(s) (APIs) 122, contact center queue(s) 123, split algorithm 124, queue manager 125, and management instruction set 126. The communication router 121 can be any hardware coupled with software that can route communications and/or service requests in contact center 120, such as a Private Branch Exchange (PBX), a switch, a session manager, a communication manager, a router, an email system, an instant messaging system, a text messaging system, a video switch, and/or the like. Communication router 121 can route various kinds of communications, such as voice calls, video calls, Instant Messaging (IM), text messaging, emails, virtual reality communications, and/or the like.

API(s) 122 may include an administrative API that allows administrators and/or supervisors in contact center 120 to use new algorithm or data sources to improve performance. For example, API(s) 122 may include various APIs to communicate with various social media sites, such as Linkedin®, Facebook®, Twitter®. APIs 122 may also include APIs to the weather channel or first responders. Additionally, APIs 122 may provide additional services, such as recording calls, providing additional content while customers are on hold, etc.

Contact center queue(s) 123A-N are queues for holding incoming and/or outgoing communications/service requests for contact center 120. Contact center queue(s) 123A-N can hold similar types of communications (e.g., voice calls only) or different types of communications (e.g., voice, video, text messaging, email, and/or IM communications). Contact center queue(s) 123A-N may be implemented in various manners, such as, on a first-in-first-out (FIFO) basis. In some embodiments, calls may be placed higher in contact center queues 123A-N based on various metrics. For example, a gold customer (a paying customer) may get preferential treatment over other non-paying customers by being placed higher in the contact center queue. This may be determined based on the number the customer dials to connect to contact center 120. Contact center queue(s) 123A-N may be dynamically defined to have different amounts and/or types of communications that can be held in contact center queue(s) 123A-N. For example, contact center queue 123A may be initially configured to support thirty voice calls and fifty IM chat sessions. Later, the same contact center queue 123A may be dynamically configured to support twenty-five voice calls, thirty IM sessions, and seventy-five emails. Additional agents may have been added to queue 123A in order to increase the bandwidth of the queue.

Although not shown, the contact center 120 may be implemented as a queue-less contact center 120. In a queue-less contact center 120, the communications are placed into a pool where contact center agents 131A-N may select which communications are to be worked on. In some embodiments, a queue-less contact center utilizes other means to route and prioritize the service requests.

The splits 141A-N are skill groups that are typically associated with one or more products and/or services that are supported by the contact center agents 131A-N. For example, a first split 141A may be created to support Company A's mobile phones, and a second split 141B may be created to support the cellular service associated with the mobile phones. A split/skill group is typically associated with a contact center queue. In some embodiments, there may be an individual split for each contact center queue (e.g. a one-to-one ratio). Alternatively, a split may be associated with two or more contact center queues or a contact center queue may be associated with two or more skill groups. One of skill in the art could envision various combinations of contact center queue(s) 123A-N/splits 141A-N. A split may comprise human agent(s) (e.g., contact center agents 131A-131N) and/or non-human agent(s) (e.g., an IVR system(s) automated agent(s)).

A split may be specific to a particular communication type. For example, a product/service may have separate split 141A-N for voice, video, email, IM, text messaging, and virtual reality communications. Alternatively, splits 141A-N may support all or only a portion of the supported communication types.

In one embodiment a split 141B may comprise a web chat forum. The web chat forum may be a social media network and/or blog site where users can discuss an issue managed by contact center 120 to resolve a problem and/or issue. The web chat forum may be supervised by one or more contact center agents 131A-N and/or a supervisor.

The split algorithm 124 can comprise one or more split algorithms 124, such as K-means, Fuzzy C-means, Gaussian, EM clustering, affinity propagation, and/or the like. The split algorithm 124 may take input from various information sources, such as, communication router 121, contact center queue(s) 123, splits 141A-N, queue manager 125, management instruction set 126 to group agents into splits 141A-N. The agents that are groups to create a split may be the contact center agents 131A-131N (human agents) and/or non-human agents (e.g., the IVR system(s) and/or automated agents).

The automated agent(s) can be or may include any hardware coupled with software that can automatically respond to a communication. For example, the automated agent may respond automatically to an email based on the subject matter of the email. Alternatively, the automated agent may automatically respond to a voice communication (e.g., by using an IVR system), a video communication (e.g., by playing a video that answers the customer's questions), a prepared IM communication/SMS message, and/or the like.

The queue manager 125 can be or may include any hardware coupled with software that can gather and manage information from various sources, such as the communication router 121, API(s) 122, contact center queue(s) 123, and/or the like. The queue manager 125 gathers information from various places that are relevant to the contact center's products and services.

Agents 131A-N may use terminals, which can be or may include any communication devices used by the contact center agents 131A-131N to handle incoming/outgoing communications, such as device 101A. The agent terminals may comprise multiple communication devices. For example, a contact center agent may have a telephone and a desktop computer to handle service requests for the contact center 120.

FIG. 1B illustrates another embodiment of system 100 where a new split/skill group 152 is created to handle smart queue 151 including dynamic service requests from device 102. Although, only one device 102 is shown for clarity, it is understood that the dynamic service requests may comprise multiple related service requests from multiple devices. For example, if there is a new product released, then many customers may call with questions related to the new product. In another example, if there is an emergency or disaster, then service calls may increase with people trying to find out information about the emergency/disaster. For example, callers may be trying to find out information on evacuation.

Split 152 includes agents 131B, E, and H. The agents may also remain in their original splits. For example, agent 131B is in split 141A and 152 and may receive and handle service requests from the queues associated with each split. Similarly, Agent 131E is in split 141B and 152, and may handle service requests from each associated split. Agent 131H may not have previously been in a split/skill group and may have handled service requests from a general queue, therefore, agent 131H may continue to handle service requests from the general queue, in addition to requests from the smart queue. In some embodiments, agents are only assigned to one split and are removed from their original split when they are added to a new split.

In some embodiments, smart queue 151 is not a separate queue, and contact center 120 is able to intelligently manage the dynamic service requests by inserting them into existing queues 123A-N, based on factors such as, wait time, average call time, agent availability, etc. In some examples, data is added to the service requests that indicate routing information, priority information, skill group information, etc. this information is used by communication router 121 to route the service requests.

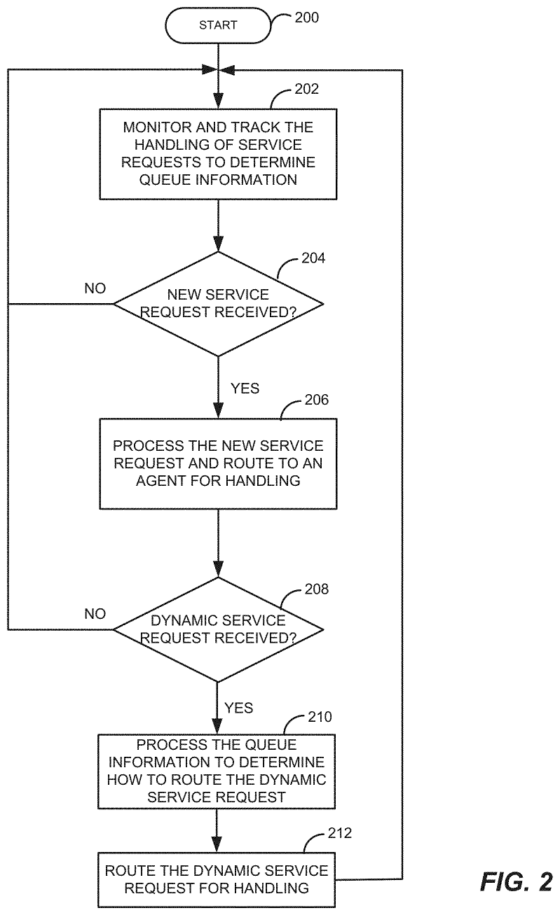

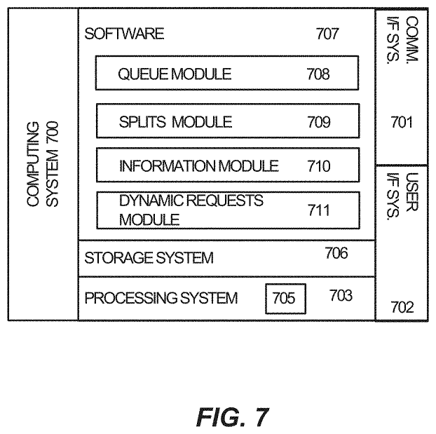

Contact center 120 may include a computer or microprocessor, as illustrated in FIG. 7, which performs the method of FIGS. 2-6 and the processes described herein by executing program instructions stored in a computer readable storage medium, such as a memory (i.e., a computer memory, a hard disk, and/or the like). Although the methods described in FIGS. 2-6 are shown in a specific order, one of skill in the art would recognize that the steps in FIGS. 2-6 may be implemented in different orders and/or be implemented in a multi-threaded environment. Moreover, various steps may be omitted or added based on implementation.

Referring to FIG. 2, which illustrates a process to intelligently manage multi-channel interactions in contact center 120. The process starts in step 200. Queue manager 125 monitors and tracks in real-time the handling of service requests in contact center 120 to determine queue information (step 202). Examples of queue information include wait times, number of agents, number of available agents, average call time, number and/or type of skills groups, and/or other queue information including combinations thereof. Queue manager 125 can gather information in various ways. For example, queue manager 125 may monitor incoming and/or outgoing communications. Queue manager 125 may monitor voice, video, IM, email, text, and/or virtual reality communications for key words to identify trends that are occurring. For instance, queue manager 125 may identify that there is a specific type of problem in a newly released product serviced by contact center 120 by identifying keywords (e.g., the name of the product, the word “problem,” and the phrase “cannot configure”) in communications coming into contact center 120. The keywords may trigger an action (e.g., to reconfigure routing of communications) based on a number of keyword hits (i.e., a threshold). Alternatively, another application may identify keywords or information and then provide the information to queue manager 125.

In some embodiments, queue manager 125 may gather information from Interactive Voice Recognition (IVR) Systems. For example, queue manager 125 may get menu selections made by callers from the IVR system(s). Queue manager 125 may learn that a selection of a menu item (i.e., for a specific product) has increased 300% in the last twenty-four hours. Queue manager 125 may learn dissatisfaction of customers by monitoring a caller's voice (e.g., tone/inflection) with the IVR system and/or while the caller is on hold in a contact center queue 123A-N. Queue manager 125 can determine information from gestures, facial expressions, movements, and/or the like in a video communication with a caller. Queue manager 125 may use call volume, email volume, IM volume, text messaging volume, virtual reality communication volume, and/or the like. Queue manager 125 may get information from contact center queue(s) 123A-N, such as the number of service requests that are currently waiting to be serviced in contact center queue(s) 123A-N. Information may be captured from splits 141A-N, such as the types of skills for each split 141A-N. Queue manager 125 may get information from the automated agents. For example, queue manager 125 may determine how many service requests are being handled by the automated agents. Queue manager 125 may receive customer feedback regarding the information provided by the automated agent(s) as an input in step 202.

Queue manager 125 may gather information based on feedback provided by the agents 131A-131N. As contact center agents 131A-131N manage communications in contact center 120, one or more of contact center agents 131A-N may identify a problem and may also identify a solution to the problem. This information can be sent to other contact center agents, so they can quickly resolve the problem. The information may also be sent to the automated agents so that when a customer is identified to have the same problem, the automated agent can automatically respond without having to involve a human center agent. This is one example of how contact center 120 may use intelligence-supported queues to improve performance.

Queue manager 125 may gather information other sources, such as the weather system, a 911 call center, or another emergency system. For example, if the weather system indicates severe weather for a city, then queue manager 125 may use this information to dynamically reconfigure contact center 120 to handle additional incoming calls based on the weather condition, such as information regarding road closures.

Additionally, queue manager 125 may gather information from other sources and communication systems (not shown), such as databases (e.g., a customer history/product/service database), networking devices (e.g., a routers and/or email systems), and/or the like. Queue manager 125 gathers information that is pertinent to products and/or services supported by contact center 120 to identify emerging trends. By identifying emerging trends in real-time, contact center 120 can be dynamically configured in real-time to better support the emerging trends. Queue manager 125 may also alert a supervisor of the emerging trends so that the supervisor can manually make changes and/or approve the dynamic changes to contact center 120. In some embodiments, the supervisor may use APIs 122 to improve performance. For example, a new instruction that prioritizes requests related to an emerging trend may be added to management instruction set 126.

If a new service request is received (step 204), then communication router 121 and/or queue manager 125 processes the new service request and routes the new service request to an agent for handling (step 206). For example, a customer may dial a number, which is routed to contact center 120. In another example, a customer may initiate a IM chat session.

If a dynamic service request is received (step 208), then queue manager 125 and/or communication router 121 may process queue information to determine how to route the dynamic service request (step 210). For example, queue manager 125 may identify a group of service requests that are related and determine that a new split should be created to handle these requests. Communication router 121 routes the dynamic service request for handling (step 212). In some embodiments, the dynamic service request(s) are placed in smart queue 151 for handling by split 152.

The above discussion describes various systems and ways that information may be captured. One of skill in the art would recognize that queue manager 125 may use various combinations of what is discussed above to dynamically reconfigure the contact center 120 to manage dynamic service requests.

In some embodiments, the dynamic service requests may be related and may be more efficiently handled by a specific skill group. For example, an unexpected software bug that was introduced by a new software patch to Product Y may project an increased volume of calls and emails to the contact center 120 for Product Y, these calls may be handled by split 141A. The current number of agents 131A-C in split 141A may not be sufficient to handle the projected increase in service requests. In some examples, queue manager 125 may be able to determine that the projected increase in service requests may be for a specific type of communication (i.e. phone calls).

In some examples, the dynamic reconfiguration of contact center 120 does not involve agents and/or splits. For example, contact center 120 may reconfigure one or more menus on an IVR system. In this example, the IVR system is reconfigured to inform the caller that the contact center 120 is aware of the problem and provides automated information to the customer rather than routing the call to an agent. For example, if contact center 120 handles service requests related to Electric Company B, then during a power outage, the IVR system may play a recorded message informing customers of anticipate repair times.

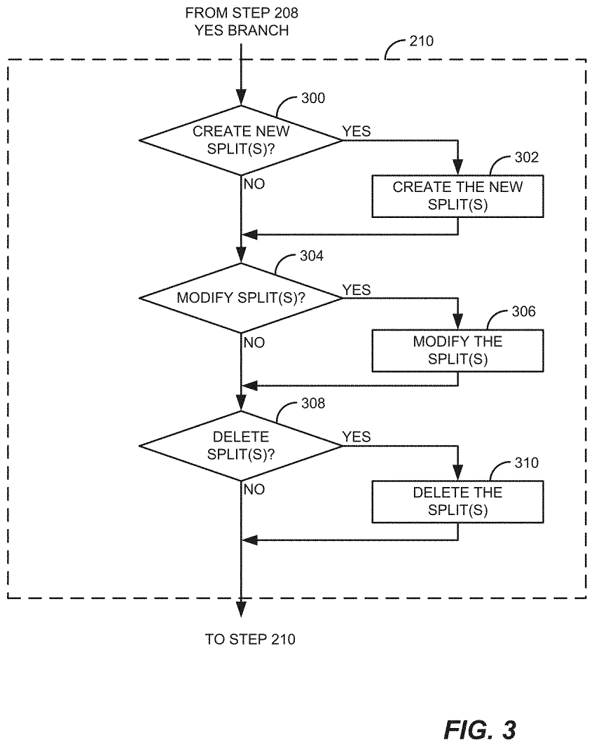

FIG. 3 is a flow diagram of a process for dynamically managing splits 141A-N for routing service requests in contact center 120. The process of FIG. 3 is an expanded view of step 210 of FIG. 2. After determining, in step 208, that that a dynamic service request is received, queue manager 125 determines, in step 300, if one or more new splits 141N are to be created. If there no split needs to be created in step 300, the process goes to step 304. Otherwise, if a split 141N is to be created in step 300, a new split 141N is created in step 302. A split 141N may be created based on a variety of factors, such as based on a new feature of a product, a new problem, a change in a product, a new demand for a product or service, a specific type of support, and/or the like. A newly created split 141N may comprise human and/or non-human agents. The process then goes to step 304.

In step 304, queue manager 125 determines if one or more existing splits 141A-N are to be modified. If there no splits 141A-N are to be modified in step 304, the process goes to step 308. Otherwise, if queue manager 125 determines, in step 304, that one or more of the existing splits 141A-N are to be modified, queue manager 125 modifies, in step 306, the one or more existing splits 141A-N. Queue manager 125 can modify an existing split 141A-N in various ways. For instance, queue manager 125 may add agents or remove agents from the existing split 141A-N based on factors, such as, a projected increase or decrease in the number of service requests. Queue manager 125 may dynamically add or remove contact center agents 131A-N based on proficiency in handling communications, this may be based on information obtained for customer feedback, and/or information about the agent's skills. For instance, queue manager 125 may dynamically add a contact center agent 131N after the contact center agent 131N has indicated completion of a particular training video.

Queue manager 125 may add a new type of agent to the existing split 141A-N. For example, queue manager 125 may add an automated agent to an existing split 141A-N that only has human agents or add human agent to a split 141A-N that only included automated agents. After modifying split(s) 141A-N, the process goes to step 308. In one embodiment, modifying the split 141A-N may be deleting from and/or adding a specific type of communication to the split 141A-N. For instance, the modification may be to remove email communications from a split 141A-N that supports audio/video/email communications. The process then goes to step 308.

Queue manager 125 determines, in step 308, if there are one or more splits 141A-N to delete. If there are no splits 141A-N to delete in step 308, the process goes to step 312. Otherwise, if there are one or more splits 141A-N to delete in step 308, the one or more splits 141A-N are deleted in step 310 and the process goes to step 312. For example, a split 141A-N may be deleted when all service requests in the associated queue are completed. In another example, a split 141A-N may be deleted when the projected demand for the split 141A-N falls below a threshold. In some embodiments, deleting a split 141A-N comprises reverting a modified split back to its original parameters, such as number of agents and/or allowed communication types. The process then goes to step 312.

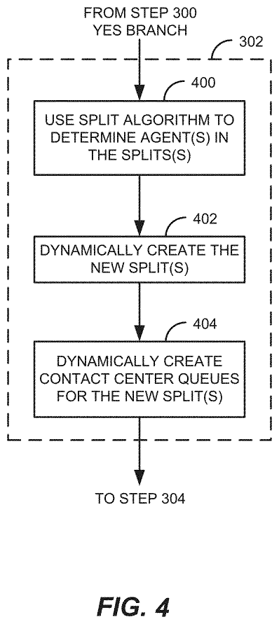

FIG. 4 is a flow diagram of a process for dynamically creating new splits 141A-N/contact center queues 123A-N in contact center 120. FIG. 4 is a detailed view of an embodiment of step 302 of FIG. 3 in contact center 120 that uses contact center queues 123A-N.

After determining that one or more splits 141A-N are to be created in step 300, queue manager 125 uses split algorithm 124, in step 400, to determine contact center agents 131A-N (may include human and automated agents) to be included in the new splits 141A-N. Split algorithm 124 may determine the agents (human and/or automated) in the new splits 141A-N based on various factors, such as skills, available agents, current staffing requirements (i.e., adding an automated agent to the new split 141A-N to better handle a high load when there are not enough contact center agents 131A-N available), a projected staffing requirement, a problem resolution (i.e., adding an automated agent 12 because a solution has been determined for a problem), and/or the like. The process of assigning agents to the new splits 141A-N may include removing agents from one or more existing splits 141A-N. Based on split algorithm 124, queue manager 125 dynamically creates the one or more splits 141A-N in step 402.

If contact center 120 also uses contact center queues 123A-N, a corresponding contact center queue 123A-N may also be created in step 404. The size (the number of communications and/or type of communications that can be held in the contact center queue) of the one or more contact center queues 123A-N may also be determined based on the number of agents 131A-N assigned to the queue. For example, for a split containing more agents, the number of service requests allowed in the corresponding queue may be higher compared to a queue associated with a split containing fewer agents. In an embodiment, instead of creating a new contact center queue, queue manager 125 may assign a new split to assist in handling service request in an existing contact center queue. If contact center 120 does not use queues, then contact center queues 123A-N will not be created in step 404. The process then goes to step 304.

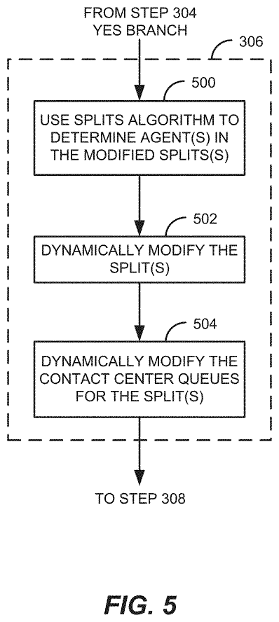

FIG. 5 is a flow diagram of a process for dynamically modifying splits 141A-N/contact center queue(s) 123A-N in contact center 120. FIG. 5 is a detailed view of an embodiment of step 306 of FIG. 3 in contact center 120 that uses contact center queues 123A-N.

After determining, in step 304, that one or more splits 141A-N need to be modified, the queue manager 125 uses split algorithm 124, in step 500, to determine agent(s) to add or delete from the one or more splits 141A-N. The agents that are added or removed from the splits 141A-N may be contact center agents 131A-N. Based on split algorithm 124, queue manager 125 dynamically modifies the one or more splits 141A-N in step 502. Queue manager 125 may dynamically modify the one or more splits 141A-N by removing one or more center agents 131A-N from one split and adding the removed agents to another split. The split algorithm of step 500 may occur dynamically over time. For example, the split algorithm of step 500 may be applied based on new skills that a contact center agent acquires.

In addition, for a queued contact center 120, queue manager 125 may dynamically modify the size of and/or change a contact center queue associated with the modified split in step 504. For example, queue manager 125 may change the size of the contact center queue by increasing or decreasing the number of service requests that the contact center queue may place on hold. Queue manager 125 may modify the types of communications that the contact center queue may hold. If contact center 120 is a queue-less contact center, then contact center queues 123A-N will not be modified in step 504. In a queue-less contact center, service requests may include data on routing and priority. The process then goes to step 308.

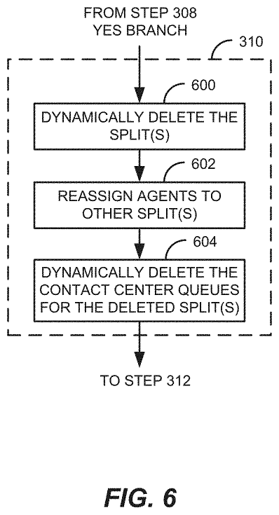

FIG. 6 is a flow diagram of a process for dynamically deleting splits 141A-N/contact center queue(s) 123A-N in contact center 120. FIG. 6 is a detailed view of an embodiment of step 310 of FIG. 3 in contact center 120 that uses contact center queues 123A-N. After determining, in step 308, that splits 141A-N need to be deleted, queue manager 125 dynamically deletes the one or more splits 141A-N in step 600. Queue manager 125 reassigns, in step 602, the agents in the deleted splits 141A-N to other splits 141A-N.

Queue manager 125 dynamically deletes, in step 604, the contact center queue(s) 123A-N associated with the deleted splits 141A-N. For example, queue manager 125 may delete a contact center queue associated with a split and change the size of another contact center queue; in this case, queue manager 125 moves the agents 131A-N that were in the deleted splits 141A-N to other splits 141A-N. The process then goes to step 312.

FIG. 7 illustrates computing system 700 used to intelligently process and route communications in a contact center as described herein, according to one implementation. Computing system 700 is representative of any computing system or systems with which the various operational architectures, processes, scenarios, and sequences disclosed herein for providing an intelligent multi-channel interaction management service in a contact center.

Computing system 700 is an example of contact center 120, although other examples may exist. Computing system 700 comprises communication interface 701, user interface 702, and processing system 703. Processing system 703 is linked to communication interface 701 and user interface 702. Processing system 703 includes a microprocessor and/or processing circuitry 705 and memory device 706 that stores operating software 707. Computing system 700 may include other well-known components such as a battery and enclosure that are not shown for clarity. Computing system 700 may comprise a server, a user device, a desktop computer, a laptop computer, a tablet computing device, or some other user communication apparatus.

Communication interface 701 comprises components that communicate over communication links, such as network cards, ports, radio frequency (RF), processing circuitry and software, or some other communication devices. Communication interface 701 may be configured to communicate over metallic, wireless, or optical links. Communication interface 701 may be configured to use Time Division Multiplex (TDM), Internet Protocol (IP), Ethernet, optical networking, wireless protocols, communication signaling, or some other communication format including combinations thereof. In some implementations, communication interface 701 is configured to communicate with other end user devices, wherein the communication interface is used to transfer and receive voice communications for the devices. Further, communication interface 701 may interface with a webservice, wherein the service may comprise a media streaming service, gaming service, a food ordering service, online banking service, or some other similar service that can be accessed via a website.

User interface 702 comprises components that interact with a user to receive user inputs and to present media and/or information. User interface 702 may include a speaker, microphone, buttons, lights, display screen, touch screen, touch pad, scroll wheel, communication port, or some other user input/output apparatus including combinations thereof. User interface 702 may be omitted in some examples.

Processing circuitry 705 comprises a microprocessor and other circuitry that retrieves and executes operating software 707 from memory device 706. Memory device 706 may include volatile and nonvolatile, removable and non-removable media implemented in any method or technology for storage of information, such as computer readable instructions, data structures, program modules, or other data. Memory device 706 may be implemented as a single storage device but may also be implemented across multiple storage devices or sub-systems. Memory device 706 may comprise additional elements, such as a controller to read operating software 707. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 705 is typically mounted on a circuit board that may also hold memory device 706 and portions of communication interface 701 and user interface 702. Operating software 707 comprises computer programs, firmware, or some other form of machine-readable program instructions. Operating software 707 includes modules 708-711, although any number of software modules within the application may provide the same operation. Operating software 707 may further include an operating system, utilities, drivers, network interfaces, applications, or some other type of software. When executed by processing circuitry 705, operating software 707 directs processing system 703 to operate computing system 700 as described herein.

In at least one implementation, queue module 708, when read and executed by processing system 703, directs processing system 703 to intelligently process and route service requests. Splits module 708, when read and executed by processing system 703, directs processing system 703 to dynamically create, modify, and delete splits. Information module 710, when read and executed by processing system 703, directs processing system 703 to gather information to be used to intelligently queue service requests. Dynamic requests module 711, when read and executed by processing system 703, directs processing system 703 to handle dynamic service requests as described herein.

It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network 110, such as a LAN and/or the Internet, or within a dedicated system. Thus, it should be appreciated, that the components of the system can be combined in to one or more devices or collocated on a particular node of a distributed network 110, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of processing and routing service requests in a contact center, the method comprising:
monitoring and tracking in real-time the handling of the service requests in the contact center to determine queue information;
receiving a new service request in a service queue;
processing the new service request to determine how to route the new service request based on a routing algorithm and routing the new service request to an agent for handling;
receiving a dynamic service request in the service queue;
processing the queue information to determine how to route the dynamic service request;
creating a new skill group and a queue for the new skull group in response to processing the queue information to determine how to route the dynamic service request, wherein the agent is assigned to the queue for the new skill group in addition to being assigned to the service queue;
routing the dynamic service request to the queue for the new skill group for handling;
assigning the dynamic service request from the queue for the new skill group to the agent; and
in response to assigning the dynamic service request from the queue for the new skill group to the agent, changing a state of the agent in both the service queue and the queue for the new skill group, wherein the state of the agent in the service queue is different than the state of the agent in the queue for the new skill group.

2. The method of claim 1 wherein the state of the agent in the service queue is changed to NOT AVAILABLE and the stale of the agent in the queue for the new skill group is chanced to ACTIVE.

3. The method of claim 2, further comprising:
deleting the new skill group after all services requests in the queue for the new skill group you have been handled.

4. The method of claim 1, further comprising:
modifying a skill group to create a modified skill group and creating a merged queue that includes service requests originally routed to the skill group and the dynamic service request.

5. The method of claim 4, wherein modifying the skill group to create a modified skill group comprises adding agents to the skill group.

6. The method of claim 4, further comprising:
reverting the modified skill group back to original parameters after the dynamic service request is complete.

7. The method of claim 1, wherein the dynamic service request comprises multiple related service requests, the method further comprising:
reconfiguring one or more menus on an IVR system.

8. The method of claim 1, wherein the service queue comprises a Vector Directory Number (VDN) queue.

9. The method of claim 1, wherein the queue for the new skill group comprises a skills split queue.

10. The method of claim 1, wherein the queue information comprises at least one of current queue wait times, skills groups, available agents, and/or a priority.

11. A system to process and route service requests in a contact center, the system comprising:
a processor;
a communication interface coupled wife the processor and configured to receive a new service request in a service queue; and
memory coupled with the processor, wherein the memory comprises instructions that, when executed by the processor, enable the processor to;
monitor and track in real-time the handling of the service requests in the contact center to determine queue information;
process the new service request to determine how to route the new service request based on a routing algorithm;
cause the new service request to be routed to an agent for handling via the communication interface;
receive a dynamic service request in the service queue;
process the queue information to determine how to route the dynamic service request;
create a new skill group and a queue for the new skill group in response to processing the queue information to determine how to route the dynamic service request, wherein the agent is assigned to the queue for the new skill group in addition to being assigned to the service queue;
route the dynamic service request to the queue for the new skill group for handling;
assign the dynamic service request from the queue for the new skill group to the agent; and
in response to assigning the dynamic service request from the queue for the new skill group to the agent, change a state of the agent in both the service queue and the queue for the new skill group, wherein the state of the agent in the service queue is different than foe state of the agent for the new skill group.

12. The system of claim 11 wherein the state of the agent in the service queue is changed to NOT AVAILABLE and the state of the agent in the queue for the new skill group is changed to ACTIVE.

13. The system of claim 12, wherein the instructions further enable the processor to:
delete the new skill group after all services requests in the queue for new skill group have been handled.

14. The system of claim 11, wherein the instructions further enable the processor to:
modify a skill group to create a modified skill group, and create a merged queue that includes service requests originally routed to the skill group and the dynamic service request, and wherein the communication interface is configured to transfer the dynamic service request to the merged queue.

15. The system of claim 14, wherein modifying the skill group to create a modified skill group comprises adding agents to the skill group.

16. The system of claim 14, wherein the instructions further enable the processor to:
revert the modified skill group back to original parameters after the dynamic service request is complete.

17. The system of claim 11, wherein the dynamic service request comprises multiple related service requests.

18. The system of claim 11, herein the service queue comprises a Vector Directory Number (VDN) queue.

19. The system of claim 11, wherein the queue for the new skill group comprises a skills split queue.

20. A non-transitory computer-readable medium comprising processor-executable instructions comprising:
instructions configured to monitor and track in real-time the handling of service requests in a contact center to determine queue information;
instructions configured to receive a new service request in a service queue and process the new service request to determine how to route the new service request based on a routing algorithm, and route the new service request to an agent for handling;
instructions configured to receive a dynamic service request in the service queue, process the queue information to determine how to route the dynamic service request, create a new skill group and a queue for the new skill group in response to processing the queue information to determine how to route the dynamic service request, and route the dynamic service request to the queue for the new skill group for handling, creating a new skid group and a queue for the new skill group in response to processing the queue information to determine how to route the dynamic service request, wherein the agent is assigned to the queue for the new skill group in addition to being assigned to the service queue;
instructions configured to assign the dynamic service request from the queue for the new skill group to the agent; and
instructions configured to change a state of the agent in both the service queue and the queue for the new skill group in response to assigning the dynamic service request from the queue for the new skill group to the agent, wherein the state of the agent in the service queue is different than the stale of the agent in the queue for the new skill group.
